(19) United States
(12) Patent Application Publication
(10) Pub. No.: US 2026/0290403 A1
(43) Pub. Date: Sep. 24, 2026

(54) RECORDING DEVICE AND COVER

(71) Applicant: NHK SPRING CO., LTD., Yokohama-shi, Kanagawa (JP)

(72) Inventors: Yusuke TANABE, Yokohama-shi, Kanagawa (JP); Masakatsu NAGASHIMA, Yokohama-shi, Kanagawa (JP); Shuji TAKAHASHI, Yokohama-shi, Kanagawa (JP)

(21) Appl. No.: 19/114,740

(22) PCT Filed: Sep. 22, 2022
(86) PCT No.: PCT/JP2023/034527

§ 371 Date: Mar. 24, 2025

(30) Foreign Application Priority Data
Sep. 30, 2022 (JP) 2022-158916

(51) Int. Cl. G11B 33/14; G11B 33/02; G11B 33/12

(52) U.S. Cl. CPC G11B 33/1466; G11B 33/027; G11B 33/12

(57) ABSTRACT

A recording device has a base accommodating an internal mechanism in a space having an opening, a cover attached to the opening of the base to close the space, and a gasket extending along an outer peripheral portion of the cover in a circumferential shape and compressed by contact to the base, wherein the gasket has a large width portion being relatively large in width spanning between an inside and an outside of the circumferential shape and a small width portion being relatively small in the width, and one or each of the cover and the base has a projection portion in a compression direction of the gasket at a portion corresponding to the small width portion to increase a compression ratio of the small width portion.

### FIELD OF THE INVENTION

The present invention relates to a recording device such as a hard disk drive and a cover used for the recording device.

### BACKGROUND OF THE INVENTION

A hard disk drive as a recording device accommodates an internal mechanism including disks being recording media in a space and requires sealability so that dust, moisture and the like are not entered into the space.

For such scalability, a gasket is generally provided between a base and a cover of a housing defining a space (Patent literature 1, for example). The gasket is circumferentially provided along an outer periphery of the cover received by the base, and is interposed and compressed between the cover and the base.

In some cases, the gasket has a small width portion in which a width spanning between an inside and an outside of a circumferential shape is partially reduced according to spatial restriction. The small width portion is easily set by variations of discharging conditions such as a discharging amount if a liquid gasket discharged from an application tool such as a needle is applied to the cover to be cured.

A projection height of the small width portion from the cover is, however, dependent on a width of the liquid gasket at the time of discharging to some extent, so that the projection height is smaller than of the other portions of the gasket. As this result, the small width portion may reduce the sealability of the gasket.

### PATENT LITERATURE 1: JPH08-045264A

### SUMMARY OF THE INVENTION

A problem to be solved is that there is a risk to reduce a projection height to lower sealability at a small width portion of a gasket.

The present invention provides a recording device having a base accommodating an internal mechanism in a space having an opening, a cover attached to the opening of the base to close the space, and a gasket extending along an outer peripheral portion of the cover in a circumferential shape and compressed by contact to the base. The gasket has a large width portion being relatively large in width spanning between an inside and an outside of the circumferential shape and a small width portion being relatively small in the width. The cover or the base has a projection portion in a compression direction of the gasket at a portion corresponding to the small width portion to increase a compression ratio of the small width portion.

Further, the present invention provides a cover to be attached to an opening of a base accommodating an internal mechanism in a space to close the space. The cover has an outer peripheral portion to be received by the base, and a gasket extending along the outer peripheral portion in a circumferential shape to be compressed by contact to the base. The gasket has a large width portion being relatively large in width spanning between an inside and an outside of the circumferential shape and a small width portion being relatively small in the width. The outer peripheral portion has a projection portion in a compression direction of the gasket at a portion corresponding to the small width portion to increase a compression ratio of the small width portion.

The present invention increases the compression ratio of the small width portion having a small projection height according to the projection portion, to improve sealability due to the gasket.

### BRIEF DESCRIPTION OF THE DRAWINGS

FIG. 1 is a plan view of a recording device according to an embodiment 1 of the present invention;

FIG. 2A is a schematic sectional view according to a line II-II of the recording device of FIG. 1, and FIG. 2B is a schematic sectional view according to a modified embodiment;

FIG. 3A and FIG. 3B are schematic sectional views illustrating part of FIG. 2A with enlargement;

FIG. 4 is a bottom view of a cover of the recording device of FIG. 1.

FIG. 5 is a bottom view of the cover illustrating a small width portion and its periphery of the gasket of FIG. 4 with enlargement;

FIG. 6A is a longitudinal cross-section according to a line VI-VI of FIG. 5, and FIG. 6B is a longitudinal cross-section illustrating a state before the cover is attached to a base of FIG. 6A;

FIG. 7A is a transverse cross-section according to a line VIIA-VIIA of FIG. 5A, and

FIG. 7B is a transverse cross-section according to a line VIIB-VIIB of FIG. 5A;

FIG. 8 is a transverse cross-section illustrating a small width portion and its periphery of a gasket according to a modified embodiment of the embodiment 1 of the present invention;

FIG. 9A is a longitudinal cross-section illustrating a small width portion and its periphery of a gasket according to an embodiment 2 of the present invention, and FIG. 9B is a longitudinal cross-section illustrating a state before a cover is attached to a base of FIG. 9A;

FIG. 10 is a transverse cross-section according to a line X-X of FIG. 9A ;

FIG. 11A-(C) are transverse cross-sections illustrating small width portions and their periphery of gaskets according to modified embodiments of the embodiment 2;

FIG. 12 is a longitudinal cross-section illustrating a small width portion and its periphery of a gasket according to an embodiment 3 of the present invention; and

FIG. 13 is a bottom view of a cover illustrating a small width portion and its periphery of a gasket according to an embodiment 4 of the present invention.

### EMBODIMENT FOR CARRYING OUT THE INVENTION

The object of improving sealability of a gasket having a small width portion is accomplished by provision of a projection portion to increase a compression ratio of the small width portion.

As illustrated in drawings, a recording device 1 is provided with a base 17, a cover 19, and a gasket 29. The base 17 accommodates an internal mechanism 5 in a space 3a having an opening 17a. The cover 19 is attached to the opening 17a of the base 17 to close the space 3a. The gasket 29 is extended along an outer peripheral portion 19a of the cover 19 and is compressed by contact to the base 17. The gasket 29 is provided with a large width portion 31 being relatively large in width spanning between an inside and an outside of the circumferential shape and a small width portion 33 being relatively small in the width. One or each of the cover 19 and the base 17 has a projection portion 37 in a compression direction of the gasket 29 at a portion corresponding to the small width portion 33 to increase a compression ratio of the small width portion 33.

The gasket 29 may be provided with a transition portion 35 between the small width portion 33 and the large width portion 31, the transition portion being gradually reduced from the large width portion 31 toward the small width portion 33 in height in the compression direction.

In a case that the projection portion 37 is provided on the cover 19, an end portion 37a of the projection portion 37 may be located in the transition portion 35. In this case, the end portion 37a of the projection portion 37 is gradually increased in height in the compression direction from a portion on the large width portion 31 side toward a portion on the small width portion 33 side in the extending direction.

In a case that the projection portion 37 is provided on the base 17, the projection portion 37 may be located so that the end portion 37a in the extending direction faces the transition portion 35. In this case, the end portion 37a of the projection portion 37 is gradually increased in height in the compression direction from a portion on the large width portion 31 side in the extending direction toward a portion on the small width portion 33 side in the extending direction.

The small width portion 33 and the large width portion 31 may be eccentric in a width direction of the gasket 29.

The projection portion 37 may be formed smaller than the small width portion 33 in the width direction of the gasket 29, and the projection portion 37 and the small width portion 33 may be eccentric in the width direction.

In the cover 19 having the projection portion 37 and used for the recording device 1, the gasket 29 extends along the outer peripheral portion 19a received by the base 17 in the circumferential shape. The gasket 29 has the large width portion 31 being relatively large in width spanning between the inside and the outside of the circumferential shape and the small width portion 33 being relatively small in the width, and the outer peripheral portion 19a has the projection portion 37 in the compression direction of the gasket 29 at the portion corresponding to the small width portion 33 to increase the compression ratio of the small width portion 33.

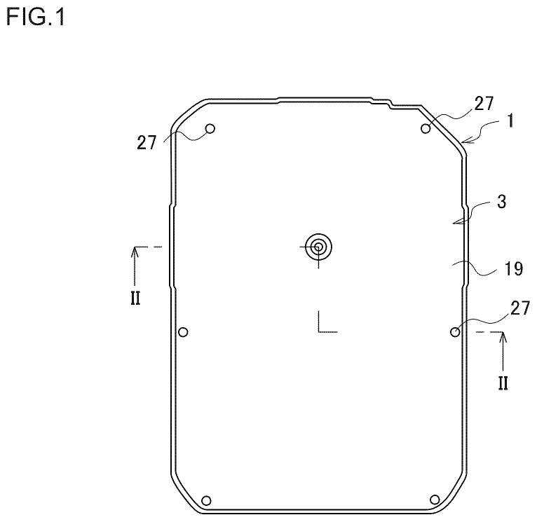

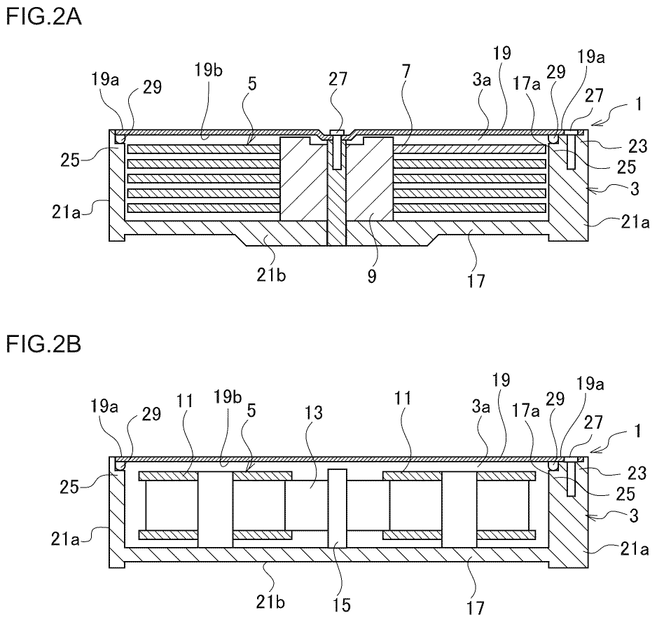

FIG. 1 is a plan view of a recording device according to the embodiment 1 of the present invention. FIG. 2A is a schematic sectional view according to a line II-II of the recording device of FIG. 1, and FIG. 2B is a schematic sectional view according to a modified embodiment.

A recording device 1 of the present embodiment is a hard disk drive as a magnetic disk device, and accommodates an internal mechanism 5 in a space 3a within a housing 3.

The internal mechanism5 is provided with a spindle motor 9 and the like in addition to disks 7 being recording media. The disks 7 are stacked in a plural in a thickness direction of the recording device 1 (hereinafter, referred to simply as “thickness direction”), and are rotatably supported by the spindle motor 9. The disks 7 are configured so that information is written and read through heads not illustrated.

It should be noted that the recording device 1 is not limited to the magnetic disk device and may be another disk device such as optical disk device or another recording device other than the disk device. For example, the recording device 1 may be a tape-embedded type drive as illustrated in FIG. 2B. This recording device 1 accommodates a tape film 13 as a recoding medium wound between two tape reels 11 and a head assembly 15 to read and write information in the space 3a of the housing 3 as the internal mechanism 5.

The housing 3 is composed of a base 17, and a cover 19 to be closed or sealed inside.

The base 17 is made of metal such as aluminum, and is formed into a box shape having an opening 17a communicating with the space3a on one side in the thickness direction. It should be noted that the base 17 is sufficient to be a box shape capable of accommodating the internal mechanism 5 including the disks 7, and may have an appropriate shape in this context. The base 17 of the present invention is formed into an approximate rectangular shape in a plan view, for example. In addition, the plan view means a state seen in the thickness direction and does not mean to distinguish a plan and a bottom.

The base 17 is closed by the cover 19 attached to the opening 17a on the one side in the thickness direction. This seals the space 3a in the housing 3 accommodating the internal mechanism 5. The sealed space 3a may seal gas such as helium with lower resistance than air.

A side wall portion 21a is provided circumferentially on an outer peripheral portion of the base 17 so that the opening 17a of the base 17 is defined by the side wall portion 21a. In addition, the outer peripheral portion of the base 17 is an outer peripheral region surrounding the internal mechanism 5, and is a portion on which the side wall portion 21a is provided in the present embodiment.

The side wall portion 21a is raised integrally from a bottom wall portion 21b of the base 17, the bottom wall portion formed into a plate shape. The side wall portion 21a may be, however, formed separately from the bottom wall portion 21b of the base 17 and be connected to the bottom wall portion to be unified to the bottom wall portion.

The side wall portion 21a is provided with fastening portions 23 and a cover-receiving portion 25.

The fastening portions 23 of the base 17 are portions at which the cover 19 is fastened with respect to the base 17. In the present embodiment, the fastening portions 23 are provided at a plurality of positions, for example, 6 positions so as to be spaced in a circumferential direction of the base 17. It should be noted that the fastening portion 23 may be circumferentially formed along the outer peripheral portion of the base 17. The circumferential direction of the base 17 means a circumferential direction along the side wall portion 21a of the base 17.

The fastening portions 23 are in contact with the cover 19 to receive the cover in the thickness direction. In this contact state, the cover 19 is fastened to the fastening portions 23 using fastening tools, for example, bolts 27. In addition, the cover 19 is also fastened to the spindle motor 9 using the bolt 27. As the fastening tools, rivets or the like may be used instead of the bolts 27.

The cover-receiving portion 25 receives the outer peripheral portion 19a of the cover 19 with interposition of the gasket 29 attached to the cover 19. With this, the gasket 29 is compressed between the cover-receiving portion 25 and the cover 19 in the thickness direction.

The cover-receiving portion 25 of the present embodiment is provided circumferentially along the side wall portion 21a of the base 17 in the plan view. The cover-receiving portion 25 may be, however, partially provided on the outer peripheral portion of the base 17.

The cover-receiving portion 25 has a receiving face 25a. The receiving face 25a is formed flat along a width direction. The outer peripheral portion 19a of the cover 19 is received by the receiving face 25a with which the gasket 29 is brought into contact. It should be noted that the receiving face 25a may not be flat and may have irregularities or the like as long as the gasket 29 is brought into contact with the receiving face.

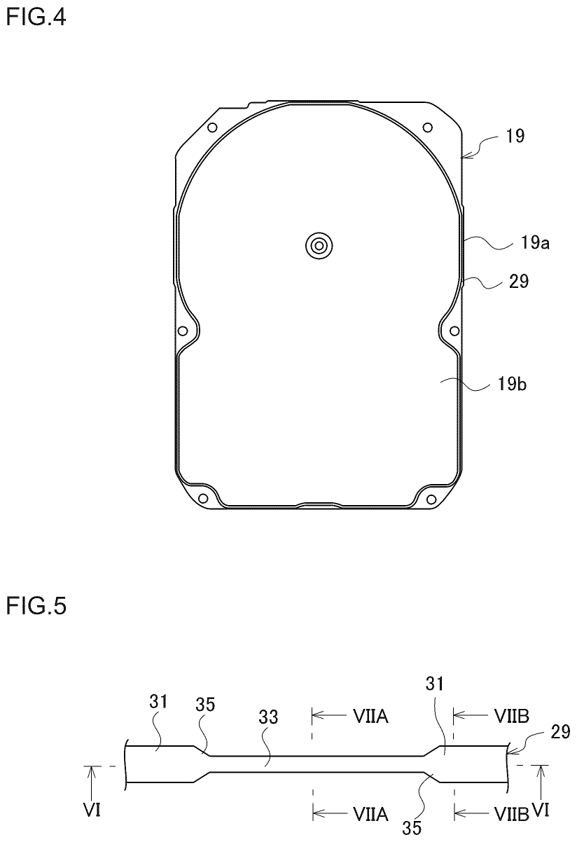

FIG. 4 is a bottom view of the cover of the recording device of FIG. 1.

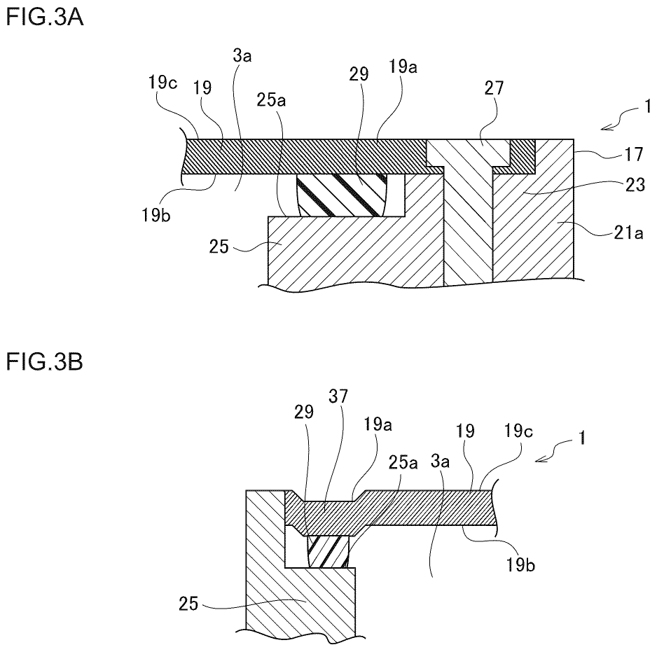

As illustrated in FIGS. 1-4, the cover 19 is formed of a plate material made of metal such as stainless steel. The cover 19 is formed entirely into a flat plate shape covering the opening 17a of the base 17. The cover 19 of the present embodiment is formed into an approximate rectangular shape corresponding to the base 17 in the plan view. A form such as shape of the cover 19, however, is not limited particularly as long as the cover covers the opening 17a of the base 17. Further, the material of the cover 19 is optional.

The cover 19 is received by the base 17 at the outer peripheral portion 19a in a state of covering the opening 17a of the base 17. In particular, the outer peripheral portion 19a of the base 17 is received by the cover-receiving portion 25 of the base 17 in the thickness direction. In addition, the outer peripheral portion 19a is a circumferential portion received by the base 17. To the outer peripheral portion 19a of the cover 19, the gasket 29 for sealing is attached.

The gasket 29 is extended circumferentially along the outer peripheral portion 19a of the cover 19. The gasket 29 is projected from the outer peripheral portion 19a in the thickness direction and is compressed by contact with the base 17. In particular, the gasket 29 projected form the outer peripheral portion 19a of the cover 19 is in contact with the cover-receiving portion 25 of the base 17, and is compressed and interposed between the base 17 and the cover 19 according to fixing of the cover 19 to the base 17.

It should be noted that, although a projection direction and a compression direction of the gasket 29 are identical with the thickness direction according to the present embodiment, the projection direction and the compression direction may be different from the thickness direction. Further, the projection direction and the compression direction of the gasket 29 may be different from each other as long as the gasket 29 is compressed to ensure sealability. Hereinafter, the present embodiment provide the explanation while regarding the projection direction and the compression direction as the thickness direction unless it be necessary.

The compressed gasket 29 seals between the cover 19 and the base 17. The gasket 29 of the present embodiment is compressed between the cover 19 and the cover-receiving portion 25 of the base 17 to seal between the cover 19 and the cover-receiving portion 25.

For the gasket 29 of the present embodiment, a liquid gasket such as FIPG (Formed In Place Gasket) is used. Namely, the gasket 29 is discharged from a needle or the like to be applied onto the outer peripheral portion 19a of the cover 19 in advance, and is cured to be fixed.

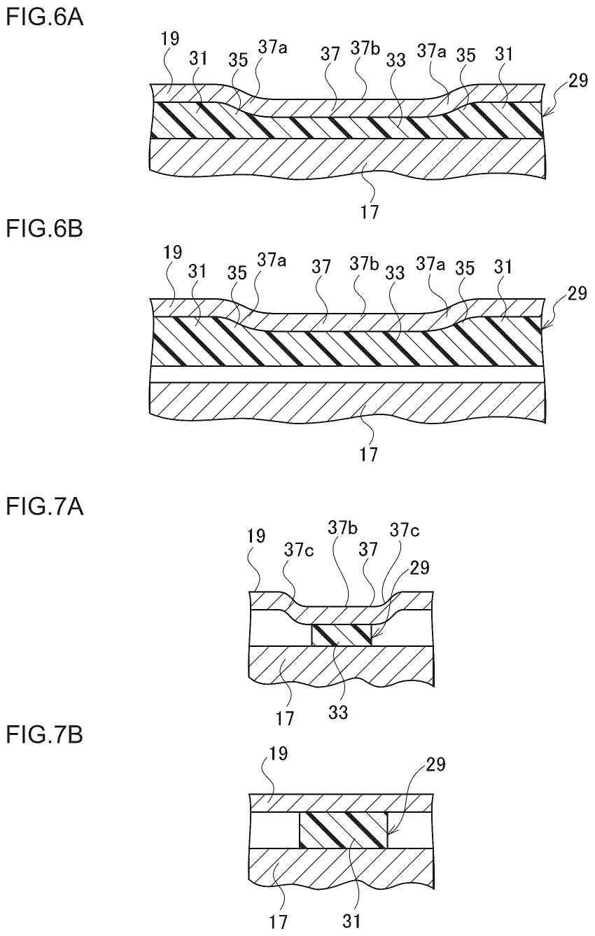

FIG. 5 is a bottom view of the cover 19 illustrating a small width portion 33 and its periphery of the gasket 29 of FIG. 4 with enlargement. FIG. 6A is a longitudinal cross-section according to a line VI-VI of FIG. 5, and FIG. 6B is a longitudinal cross-section illustrating a state before the cover 19 is attached to the base 17 of FIG. 6A. FIG. 7A is a transverse cross-section according to a line VIIA-VIIA of FIG. 5A, and FIG. 7B is a transverse cross-section according to a line VIIB-VIIB of FIG. 5A.

The gasket 29 of the present embodiment is provided with large width portions 31 and the small width portion 33.

The large width portion 31 is a portion being relatively large in width spanning between an inside and an outside of the circumferential shape of the gasket 29 and the small width portion 33 is a portion being relatively small in the width spanning between the inside and the outside of the circumferential shape of the gasket 29.

The small width portion 33 is a portion of the gasket 29 in the extending direction, the portion reduced in width according to spatial restriction for avoiding interference to the internal mechanism 5 or the like. It should be noted that one or more small width portions 33 are provided in the extending direction.

The large width portions 31 and small width portion 33 are concentrically arranged in the width direction in a transverse cross-section orthogonal to the extending direction of the gasket 29. The concentricity is that widthwise centers of the large width portions 31 and the small width portion 33 are concentric in the width direction.

The large width portions 31 and the small width portion 33 are set in width and height in the thickness direction when a liquid gasket is discharged from an application tool such as a needle. In particular, the width and the height in the case of curing the liquid gasket discharged from the application tool have correlation in which only any one of the width and the height is not increased or reduced in a single layer. According to this correlation, the large width portions 31 and the small width portion 33 are set in width and height. With this, the small width portion 33 is lower than the large width portion 31 in height according to the width.

Although the widths of the small width portion 33 and the large width portion 31 are largest widths (maximum widths) in the small width portion 33 and the large width portion 31 in a free state, respectively, the widths may be smallest widths (minimum widths), averages of the widths or the like. In the large width portion 31 and the small width portion 33, although the respective widths are constant, the widths may be varied in the extending direction. In addition, the free state is an unloaded state in which no compression load acts on the gasket 29 and an unclosed state before the opening 17a of the base 17 is closed by the cover 19 in the present embodiment.

Although the heights of the of the small width portion 33 and the large width portion 31 are largest heights (maximum heights) in the small width portion 33 and the large width portion 31 in a free state, respectively, the heights may be smallest heights (minimum widths), averages of the heights or the like. In the large width portion 31 and the small width portion 33, although the respective heights are constant, the heights may be varied in the extending direction.

In addition, adjustment of the widths (and heights) of the large width portion 31 and the small width portion 33 may be performed by varying discharging conditions, for example, a discharging amount of the gasket 29, moving speed of the application tool such as the needle, a distance between an application face of the cover 19 and the application tool and the like. The moving speed of the application tool is moving speed in the extending direction.

Transition portions 35 are provided between the large width portions 31 and the small width portion 31. The transition portions 35 are gradually reduced in width and height from the large width portions 31 toward the small width portion 31. The gradually reducing in width and height is reduction continuous or stepwise in width and height. Although the transition portion 35 of the present embodiment is formed into inclined shapes on each side in the width direction explained later and on a face contacting the cover 19 so as to be reduced in width and height, the shape of the transition portion 35 may be optionally set.

For example, the width and the height of the transition portion 35 may be reduced with a parabolic shape, and any one thereof may be an inclined shape and the other may be a parabolic shape. Further, one gradually reducing in width and height may be a shape in which portions continuously reducing in width and height are connected by portions with fixed widths and heights or a shape in which portions with fixed different widths and heights are connected.

In a portion corresponding to the small width portion 33 of the gasket 29, the cover 19 is provided with a projection portion 37. The projection portion 37 is a projection portion in the thickness direction being the compression direction of the gasket 29 to increase a compression ratio of the small width portion 33. It should be noted that the portion corresponding to the small width portion 33 of the cover 19 is a portion on which the small width portion 33 is provided. Accordingly, the present invention makes a state in which the small width portion 33 is raised by the projection portion 37. The raising means that the small width portion 33 is heightened in the thickness direction by comparison with a case having no projection 37.

The compression ratio is indicated with (H-h)/H in which h is the height of the gasket 29 in a compressed state and H is the height of the gasket 29 in the free state. The increase in the compression ratio of the small width portion 33 is increase of the compression ratio of the small width portion 33 by comparison with a case having no projection portion 37. The increase of the compression ratio of the small width portion 33 is performed such that the compression ratio of the small width portion 33 is increased, reduced or identical with respect to the compression ratio of the large width portion 31. In any cases, it is preferably that difference between the compression ratio of the small width portion 33 and the compression ratio of the large width portion 31 is reduced.

This configuration suppresses variation in projection height in the thickness direction between the small width portion 33 and the large width portion 31 in the free state of the gasket 29 and increases the compression ratio of the small width portion 33. This improves sealability according to the gasket 29.

It should be noted that the projection height is a height in the thickness direction being the projection direction of the gasket 29 from a portion of the cover 19 having no projection portion 37 and is different from the height being a dimension of the gasket 29 in the thickness direction. The projection height of the gasket 29 of the present embodiment is even between the small width portion 33 and the large width portion 31 in the free state. The small width portion 33 may be, however, smaller or larger than the large width portion 31 in the projection height.

According to the present embodiment, the projection portion 37 is provided integrally with the cover 19. In particular, the projection portion 37 is formed by drawing or pressing of the cover 19 to project the portion corresponding to the small width portion 33 on an inner face 19b in the thickness direction. The inner face 19b is located inside the housing 3 when the cover 19 is attached to the base 17. An outer face 19c is located outside the housing 3 when the cover 19 is attached to the base 17.

It should be noted that the projection portion 37 may be fixed to the cover 19 after the projection portion is formed separately from the cover 19. Fixing means may employ an appropriate one such as sticking or welding. If the projection portion 37 is integrated with the cover 19, the projection portion has a barrier property superior to the gasket 29. If the projection portion 37 is a different body from the cover 19, the projection portion preferably has a barrier property equivalent or superior to the gasket 29.

The projection portion 37 of the present embodiment is located in the transition portions 35 at end portions 37a in the extending direction. The end portion 37a is gradually increased in height in the thickness direction from a portion on the large width portion 31 side toward a portion on the small width portion 33 side in the extending direction. The transition portion 35 is provided to follow the end portion 37a, thereby smoothly transitioning from the large width portion 31 to the small width portion 33 while suppressing variation of the projection height of the gasket 29. This ensures the sealability of the gasket 29.

The gradually increasing in height of the end portion 37a is continuous or stepwise increase in height. Although the end portion 37a of the present embodiment continuously increases in height with an inclined shape, the shape of the end portion may be optionally set.

For example, the height of the end portion 37a may be increased with a parabolic shape. Further, one gradually increasing in height may be a shape in which portions continuously increasing in height are connected by portions with fixed heights or a shape in which portions with fixed different heights are connected.

A body portion 37b between the end portions 37a of the projection portion 37 has a flat-plate shape and has a constant height in the thickness direction. The height of the body portion 37b defines the height of the projection portion 37 in the thickness direction. It is preferable that the height of the projection portion 37 in the thickness direction exceeds 0, and is less than twice as much as a difference in height (dimensional difference in the thickness direction) between the small width portion 33 and the large width portion 31 in the free state. More preferably, the height of the body portion 37b is 0.5 to 1.5 times as much as the difference in height between the small width portion 33 and the large width portion 31 in the free state. This is because it preferably suppresses variation in height between the small width portion 33 and the large width portion 31 in order to ensure the sealability of the gasket 29. According to the present embodiment, the height of the projection portion 37 is smaller than the thickness of the cover 19 and equivalent to the difference in height between the small width portion 33 and the large width portion 31.

The body portion 37b keeps flatness high according to rib effect. The small width portion 33 of the gasket 29 is located on the body portion 37b having the high flatness, thereby to further improve the sealability.

Widthwise end portions 37c of the projection portion 37 are gradually increased in height from both sides to the body portion 37b in the width direction similar to the end portion 37a. Although the end portions 37c of the present embodiment are continuously increased in height with inclined shapes, the shapes of the end portions may be optionally set similar to the end portion 37a.

In manufacturing of the recording device 1 of the present embodiment, the cover 19 is attached to the base 17 of the housing 3 accommodating the internal mechanism 5 including the disks 7, to close the space 3a of the housing 3 accommodating the disks 7.

Namely, the cover 19 to which the gasket 29 is attached is faced to the opening 17a of the base 17 in the thickness direction. In this state, the cover 19 and the base 17 are closer to each other to bring a tip end portion of the gasket 29 into contact with the cover-receiving portion 25 of the base 17.

The cover 19 and the base 17 are further closer to each other so that the gasket 29 is compressed between the cover 19 and the base 17. At this time, since the gasket 29 of the present embodiment is increased in projection height at the small width portion 33 according to the raising based on the projection portion 37. Accordingly, the gasket 29 is increased in the compression ratio at the small width portion 33. The gasket 29 is, therefore, sufficiently compressed at the small width portion 33 as well as the large width portion 31, thereby improving in sealability as a whole.

Further, the height of the projection portion 37 is less than twice as much as the difference in height between the small width portion 33 and the large width portion 31, so that it suppresses the variation in height between the small width portion 33 and the large width portion 31 to ensure the sealability of the gasket 29. In particular, the present embodiment sets the height of the projection portion 37 to be the same as the difference in height between the small width portion 33 and the large width portion 31, so that the projection height of the gasket 29 is even between the small width portion 33 and the large width portion 31. Accordingly, the tip end of the gasket 29 in the thickness direction is smooth between the small width portion 33 and the large width portion 31. The gasket 29, therefore, surely improves the sealability.

Further, the present embodiment gradually reduces the transition portion 35 between the small width portion 33 and the large width portion 31 in height toward the small width portion 33. On the other hand, the end portion 37a of the projection portion 37 is located in the transition portion 35 and is gradually increased in height toward the small width portion 33. Accordingly, it more surely suppresses the variation in projection height of the gasket 29 to improve the sealability.

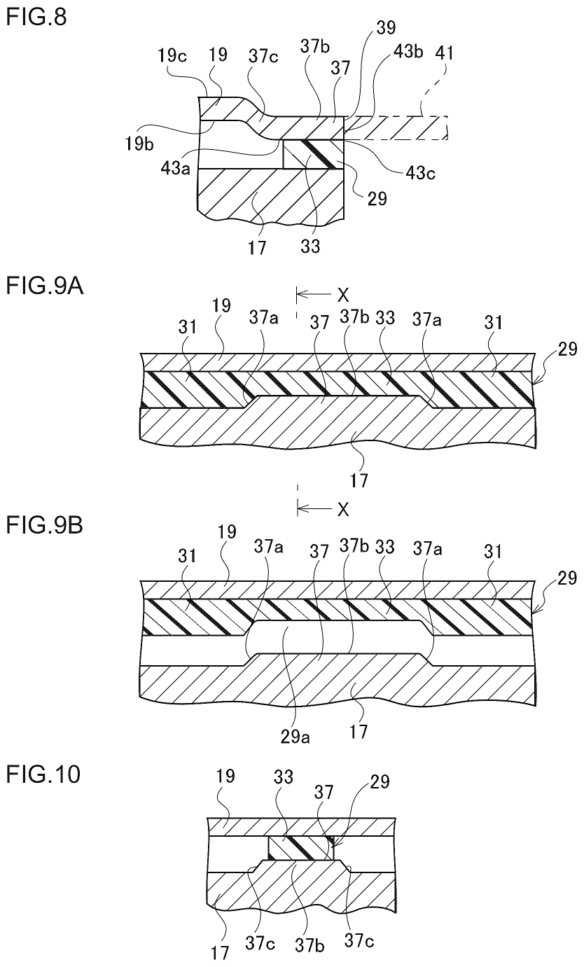

FIG. 8 is a transverse cross-section illustrating the small width portion and its periphery of the gasket 29 according to a modified embodiment of the embodiment 1 of the present invention.

In the modified embodiment of FIG. 8, the projection portion 37 is a portion sheared at the time of punching of a contour 39 of the cover 19.

Before the shearing, the projection portion 37 is integrally continuous to a connection 41 across a portion to be the contour 39 and is formed into a rib shape as well as the connection 41. The connection 41 is a portion connecting the contour 39 of the cover 19 partially to a frame outside a product or the like. The projection portion 37 is provided with a corner 43c on the basis of generating no shear drop between a top face 43a and a fracture face 43b according to a shearing direction in a state of the projection portion sheared with respect to the connection 41. The shearing direction is a direction from the outer face 19c toward the inner face 19b of the cover 19.

The modified embodiment allows the gasket 29 to be positioned closer to the corner 43c on the projection portion 37, thereby further solving spatial restriction.

FIG. 9A is a longitudinal cross-section illustrating a small width portion and its periphery of a gasket according to the embodiment 2 of the present invention, and FIG. 9B is a longitudinal cross-section illustrating a state before a cover is attached to a base of FIG. 9A. FIG. 10 is a transverse cross-section according to a line X-X of FIG. 9A. In addition, in the embodiment 2, the basic structure is in common with the embodiment 1 and therefore corresponding components are represented with the same reference numerals to eliminate duplicate explanation. The longitudinal cross-section of FIG. 9A is a cross-section along the extending direction of the gasket.

The present embodiment provides a base 17 with a projection portion 37 instead of a cover 19.

The projection portion 37 is integrally formed to the base 17 at a portion corresponding to a small width portion 33 by pressing, cutting or the like. It should be noted that the portion corresponding to the small width portion 33 is a portion facing the small width portion 33 in the thickness direction when the cover 19 is attached to the base 17. The projection portion 37 may be formed separately from the base 17 and be fixed thereto by welding, bonding or the like.

The projection portion 37 is formed into a solid projection ridge in the longitudinal cross-section along the extending direction. End portions 37a of the projection portion 37 in the extending direction are gradually increased in height in the thickness direction from a portion on a large width portion 31 side to a portion on the small width portion 33 side. In addition, the end portions 37a may be formed by faces along the thickness direction.

In the projection portion 37, widthwise end portions 37c are gradually increased in height from respective sides to a body portion 37b in a width direction in the transverse cross-section orthogonal to the extending direction. In addition, the end portions 37c may be formed by faces along the thickness direction.

The height of the body portion 37b of the projection portion 37 is equivalent to a difference in height between the large width portion 31 and the small width portion 33. This increases the small width portion 33 in a compression ratio. It should be noted that the height of the body portion 37b of the projection portion 37 may be larger or smaller than the difference in height between the large width portion 31 and the small width portion 33. In the longitudinal cross-section of FIG. 9B, if a shape of the projection portion 37 does not correspond to a shape of a recessed portion 29a formed by the small width portion 33, a gap between the projection portion 37 and the recessed portion 29a is filled by deformation of the gasket 29. According to the gap setting, the compression ratio between the large width portion 31 and the small width portion 31 may be adjusted.

A width of the body portion 37b of the projection portion 37 is larger than the width of the small width portion 33 and is smaller than the width of the large width portion 31. The width of the body portion 37b of the projection portion 37 may be, however, the same as the width of the small width portion 33 or be smaller than of the width of the small width portion 33.

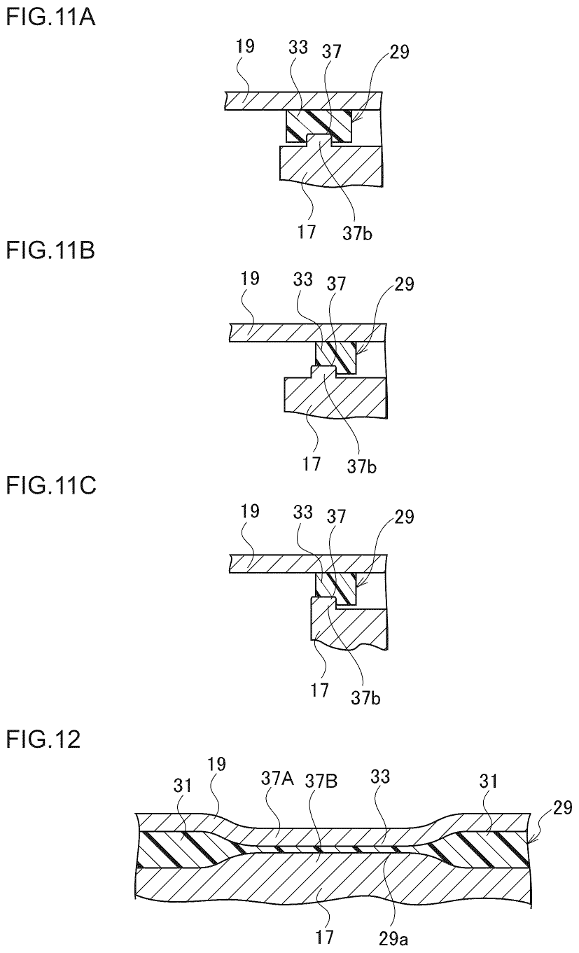

FIG. 11A-(C) are transverse cross-sections illustrating small width portions 33 and their peripheries of gaskets 29 according to modified embodiments of the embodiment 2. In addition, the transverse cross-sections of FIG. 11A-(C) are cross-sections in a direction orthogonal to the extending direction.

The modified embodiment of FIG. 11A reduces the width of the body portion 37b of the projection portion 37 with respect to the width of the small width portion 33. The projection portion 37 bites the small width portion 33 at a center portion in the width direction so that the small width portion 33 is hard to be displaced relative to the projection portion 37.

In the modified embodiments of FIG. 11B and (C), the small width portion 33 of the gasket 29 and the projection 37 are eccentric in the width direction. The eccentricity is a deviation in the width direction between a widthwise center of the small width portion 33 and a widthwise center of the projection portion 37 in the transverse cross-section orthogonal to the extending direction of the gasket 29.

In each of the modified embodiments of FIG. 11B and (C), the projection portion 37 is formed smaller than the small width portion 33 in the width direction. The projection portion 37 bites the small width portion 33 on an inner side in the width direction so that the small width portion 33 is hard to be displaced inward in the width direction of the gasket 29 relative to the projection portion 37.

In addition, in FIG. 11B, the projection portion 37 is arranged to be displaced outward from an inner edge portion of a cover-receiving portion 25 of the base 17, and in FIG. 11(C), the projection portion 37 is arranged on an inner edge portion of a cover-receiving portion 25 of the cover 17. The configurations of FIG. 11A-(C) may be applied to the projection portion 37 formed on the cover 19 of the embodiment 1.

The embodiment 2 and the modified embodiments thereof provide the same effects as the embodiment 1.

FIG. 12 is a longitudinal cross-section illustrating a small width portion and its periphery of a gasket according to the embodiment 3 of the present invention. In addition, in the embodiment 3, the basic structure is in common with the embodiment 1 and therefore corresponding components are represented with the same reference numerals to eliminate duplicate explanation.

The present embodiment provides a cover 19 and a base 17 with projection portions 37A and 37B, respectively.

The projection portion 37A is configured in the same way as the embodiment 1 and the projection portion 37B is configured in the same way as the embodiment 2. In addition, the projection portions 37A and 37B may be formed into the same sectional shape.

The small width portion 33 is formed further smaller than the embodiments 1 and 2 in height in the thickness direction and this results in the width thereof formed further smaller than of the embodiment 1 and 2. Others are the same as of the embodiment 1. It should be noted that a tip end of the small width portion 33 in the thickness direction may be any one of a form to flatly transition between the tip end and the large width portion 31 similar to the embodiment 1 and a form having a recessed portion 29a similar to the embodiment 2.

The embodiment 3 provides the same effects as the embodiments 1 and 2 and additionally makes the small width portion 33 smaller in width to be suitable to a narrower space.

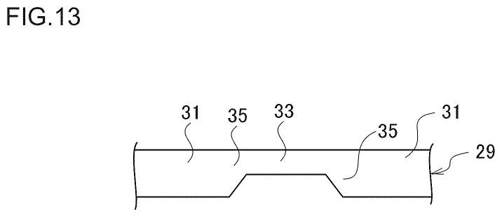

FIG. 13 is a bottom view of a cover illustrating a small width portion and its periphery of a gasket according to the embodiment 4 of the present invention. In addition, in the embodiment 4, the basic structure is in common with the embodiment 1 and therefore corresponding components are represented with the same reference numerals to eliminate duplicate explanation.

The present embodiment makes a small width portion 33 eccentric with respect to a large width portion 31 in the width direction. In response to this, a shape of a transition portion 35 is altered with respect to the embodiment 1.

An outer edge portion of the small width portion 33 corresponds to an outer edge portion of the large width portion 31 in the width direction according to the eccentricity. It should be noted that the amount of the eccentricity may be appropriately set and the outer edge portion of the small width portion 33 may not correspond to the outer edge portion of the large width portion 33. The transition portion 35 is inclined only on an inner edge portion in the width direction to be gradually reduced in width.

Even the embodiment 4 with this configuration provides the same effects as the embodiment 1. Further, it suppresses the gasket 29 from projecting inward in the width direction at the time of compression according to the eccentricity between the small width portion 33 and the large width portion 31.

1. A recording device comprising:
a base accommodating an internal mechanism in a space having an opening;
a cover attached to the opening of the base to close the space; and
a gasket extending along an outer peripheral portion of the cover in a circumferential shape and compressed by contact to the base, wherein
the gasket has a large width portion being relatively large in width spanning between an inside and an outside of the circumferential shape and a small width portion being relatively small in the width, and
one or each of the cover and the base has a projection portion in a compression direction of the gasket at a portion corresponding to the small width portion to increase a compression ratio of the small width portion.

2. The recording device according to claim 1, wherein
the gasket has a transition portion between the small width portion and the large width portion, the transition portion being gradually reduced from the large width portion toward the small width portion in height in the compression direction.

3. The recording device according to claim 2, wherein the projection portion is provided on the cover.

4. The recording device according to claim 3, wherein
an end portion of the projection portion in an extending direction of the gasket is located in the transition portion, and is gradually increased in height in the compression direction from a portion on the large width portion side in the extending direction toward a portion on the small width portion side in the extending direction.

5. The recording device according to claim 2, wherein the projection portion is provided on the base.

6. The recording device according to claim 1, wherein
the small width portion and the large width portion are eccentric in a width direction of the gasket.

7. The recording device according to claim 1, wherein
the projection portion is formed smaller than the small width portion in a width direction of the gasket, and
the projection portion and the small width portion are eccentric in the width direction.

8. A cover to be attached to an opening of a base accommodating an internal mechanism in a space to close the space, comprising:
an outer peripheral portion to be received by the base; and
a gasket extending along the outer peripheral portion in a circumferential shape to be compressed by contact to the base, wherein
the gasket has a large width portion being relatively large in width spanning between an inside and an outside of the circumferential shape and a small width portion being relatively small in the width, and
the outer peripheral portion has a projection portion in a compression direction of the gasket at a portion corresponding to the small width portion to increase a compression ratio of the small width portion.

9. The cover according to claim 8, wherein
the gasket has a transition portion between the small width portion and the large width portion, the transition portion being gradually reduced from the large width portion toward the small width portion in height in the compression direction.

10. The cover according to claim 9, wherein
an end portion of the projection portion in an extending direction of the gasket is located in the transition portion, and is gradually increased in height in the compression direction from a portion on the large width portion side in the extending direction toward a portion on the small width portion side in the extending direction.
